(19) United States
(12) Patent Application Publication
(10) Pub. No.: US 2025/0026120 A1
(43) Pub. Date: Jan. 23, 2025

(54) GLUE APPLICATION HEAD FOR BONDING, GLUING MECHANISM, AND GLUING EQUIPMENT

(71) Applicant: TCL ZHONGHUAN RENEWABLE ENERGY TECHNOLOGY CO., LTD., Tianjin (CN)

(72) Inventors: Pengfan BI, Tianjin (CN); Yannan LI, Tianjin (CN); Chuanling AI, Tianjin (CN); Yi SUN, Tianjin (CN); Shaohua FU, Tianjin (CN); Yue ZHANG, Tianjin (CN); Hongxia CEN, Tianjin (CN); Chao XIN, Tianjin (CN); Hui WEI, Tianjin (CN)

(73) Assignee: TCL ZHONGHUAN RENEWABLE ENERGY TECHNOLOGY CO., LTD., Tianjin (CN)

(21) Appl. No.: 18/548,540

(22) PCT Filed: Jul. 31, 2023
(86) PCT No.: PCT/CN2023/110429

§ 371 Date: Aug. 31, 2023

(30) Foreign Application Priority Data
Nov. 15, 2022 (CN) 202223027916.5

(51) Int. Cl. B32B 37/12; B32B 37/00

(52) U.S. Cl. CPC B32B 37/1284; B32B 37/0053

(57) ABSTRACT

A glue application head for bonding is provided, including a main body. The main body includes a cavity for storing glue and a slit for applying the glue. Through the slit, the glue in the cavity is discharged from the glue application head to be applied on a workpiece to form a glue path with a predetermined line width. Not only can a glue layer with a uniform thickness be obtained, but also a problem of no glue coming out can be prevented. Accordingly, the glue application head has improved performance in coating the glue on the workpiece, and bonding ability of the glue can also be improved. A gluing mechanism with the glue application head and a bonding equipment including the gluing mechanism are also provided. A good fit is provided between the glue application head and the workpiece to prevent no dispensing and an overflow of the glue.

### CROSS-REFERENCE TO RELATED APPLICATION

The present disclosure claims priority to and the benefit of Chinese Patent Application No. 202223027916.5, filed in the China National Intellectual Property Administration on Nov. 15, 2022, the disclosure of which is hereby incorporated by reference in its entirety.

### FIELD OF DISCLOSURE

The present disclosure relates to a technical field of silicon wafer processing, in particular to a glue application head for bonding silicon rods or material plates, a gluing mechanism with the glue application head, and a bonding equipment with the gluing mechanism.

### BACKGROUND

Glue used for bonding silicon rods is a mixture of A glue and B glue. The A glue and the B glue are mixed in a glue tube. According to lengths and splicing of monocrystalline silicon, the glue is applied on a predetermined glue path. After the monocrystalline silicon is placed, the glue is applied and cured. In conventional techniques, glue dots are applied on the silicon rods for bonding, so that a linear glue path is formed. However, this linear glue path is easily affected by flatness, roughness, and ambient temperatures of a material plate. As a result, the silicon rods have problems of no dispensing of the glue or no application of the glue during a glue pressing process, resulting in unstable bonding quality. Especially in a later phase, slicing tends to cause wobbles, thus leading to quality problems such as damaged wafers. Moreover, such a glue dispensing method makes it difficult for the silicon rods to have the glue at corners, so secondary glue application is required to be done manually, resulting in a waste of time and an uneven thickness of a glue layer. In addition to that, this glue dispensing method also reduces a thickness of the material plate after repeated cleaning. Directly dispensing glue dots causes an uneven thickness of the glue layer, and easily causes a glue overflow. On the one hand, this causes a waste of the glue. On the other hand, too much residual glue on a resin plate and tooling will affect the quality and equipment stability, so manual cleaning is required, but cleaning is difficult.

### SUMMARY

The present disclosure provides a glue application head for bonding. The present disclosure solves problems like no discharge of glue, no application of glue, and an overflow of glue when silicon rods are bonded by dispensing glue dots to form a linear glue path, which causes the silicon rods to have unstable bonding quality or easily results in damaged wafers during a slicing process.

In order to solve at least one of the above-mentioned technical problems, the present disclosure provides following technical solutions:

A glue application head for bonding, including a main body, wherein the main body includes a cavity for accommodating glue and a slit for applying the glue, and the glue application head is configured to apply the glue accommodated in the cavity on a workpiece through the slit to form a glue path with a predetermined line width.

In some embodiments of the present disclosure, the slit is straight-line shaped and is defined in a lower end surface of the main body.

In some embodiments of the present disclosure, a length of the slit is greater than 2 mm and less than a width of the workpiece.

In some embodiments of the present disclosure, the slit is defined along a length direction of the main body, and is defined along a center line of a lower end surface of the main body.

Moreover, the cavity is a groove with a flat and even surface; the cavity is defined in one sidewall inside the main body, or the cavity is defined in two sidewalls inside the main body and on two sides; and the cavity is defined along an axial plane in a length direction of the main body.

Moreover, a lower end of the cavity is adapted to a length of the slit, an upper end of the cavity directly communicates with a liquid injection port of the glue application head, and the liquid injection port of the glue application head is arranged on a top of the main body.

Moreover, a lower section of the main body includes inclined outer surfaces close to a lower end surface of the main body, and the inclined outer surfaces are all inclined toward the slit.

The present disclosure further provides a gluing mechanism with the above-mentioned glue application head. The gluing mechanism further includes a fixed frame for fixing the glue application head and a glue injection tube for injecting the glue into the glue application head, and the fixed frame is configured to drive the glue application head to move along a vertical direction and move along a width direction and a length direction of the workpiece; and the liquid injection tube is arranged on the fixed frame and directly communicates with a glue injection port of the glue application head.

Moreover, the gluing mechanism further includes a measuring instrument for measuring a thickness of the workpiece, the measuring instrument is disposed on the fixed frame, and the measuring instrument is arranged in front of the glue application head in a glue dispensing direction.

The present disclosure further provides a bonding equipment, including the above-mentioned gluing mechanism.

The present disclosure provides a glue application head for bonding, wherein a glue application structure with a strip-shaped slit is used to spread glue while moving along on a workpiece to form a glue path with a certain line width and shape. In the end, not only can a glue layer with a uniform thickness be obtained, but also a problem of no glue coming out can be prevented. Accordingly, the present disclosure has improved performance in applying the glue on the workpiece, and bonding ability of the glue can also be improved.

The present disclosure also provides a gluing mechanism with the glue application head and a bonding equipment including the gluing mechanism. By monitoring a thickness of the workpiece to control a vertical distance from the glue application head to the workpiece, the present disclosure ensures a consistent thickness of a glue layer on all glue paths on the workpiece, and allows a good fit between the glue application head and the workpiece, which can effectively prevent problems such as no application of the glue or an overflow of the glue on the glue path.

### BRIEF DESCRIPTION OF DRAWINGS

FIG. 1 is a perspective view of a glue application head according to one embodiment.

FIG. 2 is a side view of the glue application head according to one embodiment.

FIG. 3 is a front view of the glue application head according to one embodiment.

FIG. 4 is a cross-sectional view of the glue application head according to one embodiment.

FIG. 5 is a cross-sectional view of the glue application head according to another embodiment.

FIG. 6 is a gluing mechanism with the glue application head according to one embodiment.

### LIST OF REFERENCE SIGNS

| | | |
|---|---|---|
| 10: Glue application head; | 11: Main body; | 12: Cavity; |
| 13: Slit; | 14: Liquid injection port; | |
| 100: Gluing mechanism; | 20: Fixed frame; | 30: Liquid |
| | | injection tube; |
| 40: Measuring instrument. | | |

### DETAILED DESCRIPTION OF EMBODIMENTS

The present disclosure is described in detail as below in conjunction with accompanying drawings and specific embodiments.

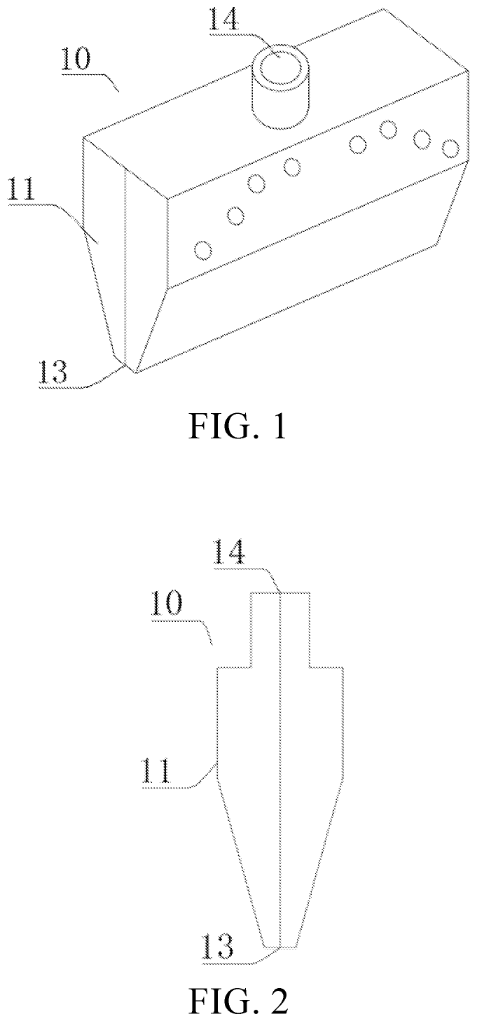

Please refer to FIG. 1. The present embodiment provides a glue application head 10 for bonding. The glue application head 10 includes a main body 11. The main body 11 includes a cavity 12 for accommodating glue and a slit 13 for applying the glue. The glue application head 10 is configured to apply the glue accommodated in the cavity 12 on a workpiece to form a glue path with a predetermined line width.

The slit 13 is an elongated straight-line structure and is defined in a lower end surface of the main body 11 to facilitate direct contact with the workpiece. During use, the glue application head 10 can be arranged vertically or inclined to contact the workpiece, as long as the glue can flow out from the slit 13 and be applied on an upper surface of the workpiece. Preferably, a length of the slit 13 is greater than 2 mm and less than a width of the workpiece. Because the slit 13 of the glue application head 10 has a strip shape, the present embodiment dispenses the glue more easily than a glue-dots dispensing method in conventional techniques. Along a length direction of the strip-shaped slit 13, the glue forms a linear glue path with a certain width, which effectively prevents a problem of not dispensing the glue. During a process of applying the glue, a friction force between the lower end surface of the main body 11 and the workpiece is utilized to spread the glue flowing out from the slit 13 to form the glue path with a certain line width, so that a glue layer with a consistent line width and a uniform thickness can be obtained, thereby preventing no dispensing of the glue and an overflow of the glue. At least one glue path is formed on the workpiece, so it is required that the length of the slit 13 be less than a width of the workpiece. Because the slit 13 has at least a certain length, a minimum length of the slit is greater than 2 mm.

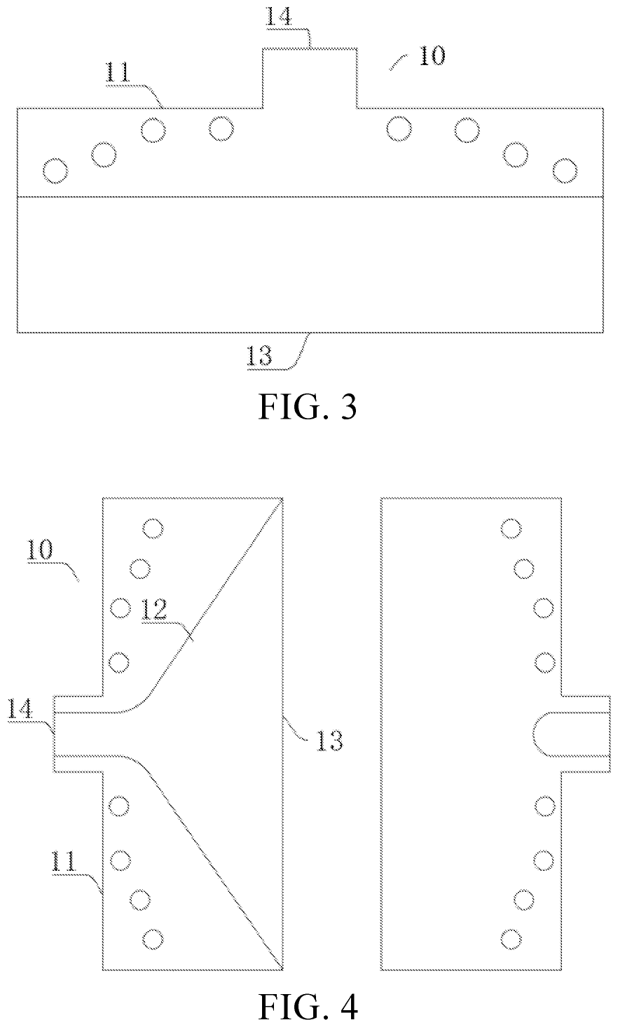

Further, the main body 11 is a cuboid. In order to shorten a glue flow path and improve fluidity of the glue, a height of the main body 11 is less than a length of the main body 11. Preferably, the main body 11 is a split structure, as shown in a side view of FIG. 2. The main body 11 includes symmetrically arranged half-body parts, which are combined into one body through connection elements. Moreover, FIG. 3 shows a front view of the main body 11. The main body 11 is convenient for processing, and facilitates assembling and maintenance. Alternatively, the main body 11 is a split structure fastened by means of engagement, that is, one side is engaged with the other side and is also connected and fixed by connection elements. Related drawings are omitted.

Further, the slit 13 is defined along a length direction of the main body 11, and is defined at a center line of the lower end surface of the main body 11, so as to prevent the slit 13 in the lower end surface of the main body 11 from being partially blocked by the glue, and at least a portion of the slit 13 can dispense the glue to prevent complete blockage. In addition to that, it is also convenient to observe uniformity of the glue path. The main body 11 has a certain length and is an overall elongated structure, so the obtained glue path is a track with an equal width, thereby ensuring consistency and stability of bonding strength.

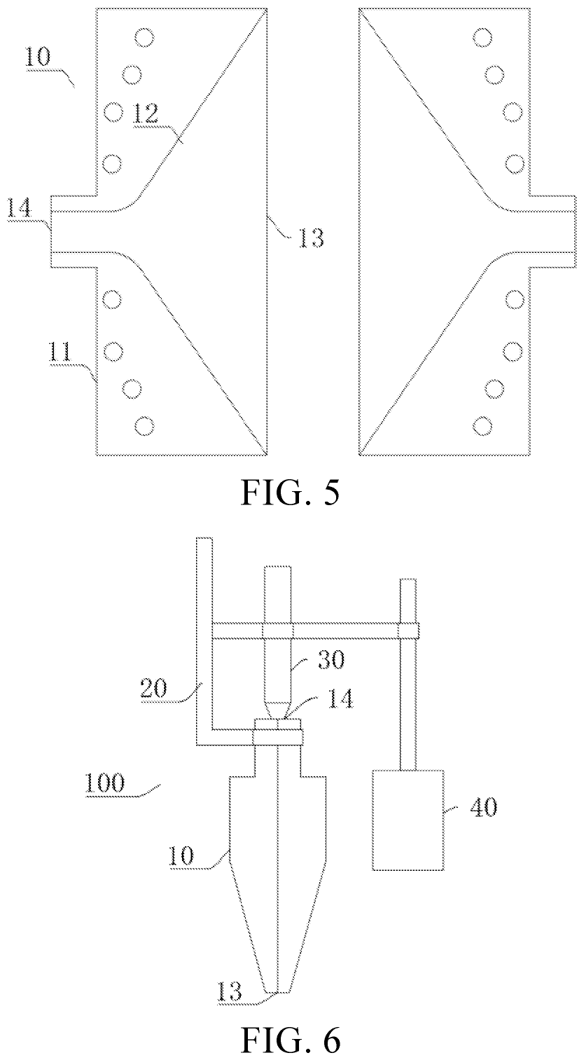

Further, the cavity 12 is configured as a groove with a flat and even surface to facilitate fluidity and storage of the glue. Preferably, the cavity is an isosceles triangular structure, as shown in FIGS. 4 to 5. In detail, a lower end of the cavity 12 is adapt to the length of the slit 13, the length of the slit 13 is the same as a length of the lower end surface of the main body 11. Certainly, the length of the slit 13 can also be less than the length of the lower end surface of the main body 11, but the slit 13 must be located in the middle of the lower end surface of the main body 11. Moreover, the cavity 12 is defined along an axial plane in the length direction of the main body 11. That is to say, the cavity 12 extends through the main body 11 along a height direction of the main body 11.

An upper end of the cavity 12 directly communicates with a liquid injection port 14 of the glue application head 10. The liquid injection port 14 is defined in the middle of a top of the main body 11, which facilitates uniform downward flowing of the glue along the entire length of the slit 13. Two sides of the cavity 12 are slope structures, and the liquid injection port 14 on the top extends downward to directly communicate with an outer end of the lower end surface of the main body 11, so that the length of the main body 11 can be utilized to the maximum extent to configure the length of the slit 13.

As shown in FIG. 4, the cavity 12 can be defined along only one sidewall inside the main body 11. That is to say, one wall surface of the cavity 12 is a flat plane on one side, and a groove is concaved into one sidewall of the main body 11 on another side to form the cavity 12; however, the liquid injection port 14 is still symmetrically configured in two opposite sidewalls, which can increase a glue injection speed and a flow speed of the glue. This structure not only can ensure the glue to fill the cavity 12, but also prevent overflow of the glue, thus improving the safety in dispensing the glue. With this structure, it is easy to distinguish a glue dispensing surface and a glue application surface. In the present embodiment, one side of the main body 11 along a glue application direction is the sidewall where the groove is defined in the main body 11. This configuration is more conducive to the dispensing of the glue and can prevent backflow of the glue.

As shown in FIG. 5, the cavity 12 is symmetrically defined in two sidewalls inside the main body 11. In other words, the cavity 12 is divided into two, and the cavity 12 is defined in the sidewalls on two sides. Two sides of the cavity 12 are combined to form a whole. This structure has strong adaptability. If there is any problem with the cavity 12 or the main body 11 on either side, replacement can be made in time. And the glue application head 10 with this structure has more liquid solution of glue, stronger dispensing ability, and better bonding performance.

In order to ensure that it is easy for the glue application head 10 to spread the glue when dispensing the glue, a lower section of the main body 11 includes inclined outer surfaces close to the lower end surface of the main body 11, and the inclined surfaces are all inclined toward the slit 13, which can reduce an overall weight and facilitate spreading the glue. As a result, the glue path with a certain width can be obtained more quickly and uniformly. In the lower section of the main body 11 close to the lower end surface, inclination angles of the inclined outer surfaces can be set based on actual conditions, and are not specifically limited herein.

Referring to FIG. 6, a gluing mechanism 100 with the above-mentioned glue application head 10 is provided. The gluing mechanism 10 is provided with a fixed frame 20 for fixing the glue application head 10 and a glue injection tube 30 for injecting the glue into the glue application head 10. The fixed frame 20 is configured to drive the glue application head 10 to move along a vertical direction and move along a width direction and a length direction of the workpiece. The liquid injection tube 30 is arranged on the fixed frame 20 and directly communicates with the glue injection port 14 of the glue application head 10. The fixed frame 20 is an L-shaped structure, and a lower end surface of the fixed frame 20 is directly fixedly connected to the glue application head 10. In the present embodiment, the glue application head 10 and the glue injection tube 30 are vertically arranged, the glue injection tube 30 directly communicates with the glue injection port 14 seamlessly, and the glue injection tube 30 is also fixed on the fixed frame 20 through a connection element. The fixed frame 20 is connected to a movement driving device (not illustrated in the drawings) disposed on the top, and can move up and down in the vertical direction, or move back and forth along the length or width direction of the workpiece, so that the glue application head 10 and the glue injection tube 30 can move synchronously. It is well known in the art as to how to control a height and horizontal and vertical movement of the glue application head 10, so a detailed description is omitted herein.

In some embodiments of the present disclosure, the gluing mechanism 100 is also provided with a measuring instrument 40 for measuring a thickness of the workpiece. The measuring instrument 40 can be a laser position sensor, an infrared position sensor, or other position sensors. The measuring instrument 40 is fixed to the fixed frame and is located directly in front of the glue application head 10 along a glue dispensing direction. The fixed frame 20 can also simultaneously drive the glue application head 10 and the measuring instrument 40 to move together in the vertical direction, the width direction of the workpiece, and the length direction of the workpiece.

The measuring instrument 40 can directly project light to a surface of the workpiece to form a projected point on the surface of the workpiece, and the workpiece reflects the light. The reflected light of the projected point can be absorbed by the measuring instrument 40. According to a reflection time and speed based on the projected point, a height from the projected point on the surface of the workpiece to an emitting end of the measuring instrument 40 can be calculated.

Based on the above-mentioned principles, before each glue path is formed, the measuring instrument 40 can be used to project along a length of the predetermined glue path, so that a height value from the measuring instrument 40 to each of two ends of the glue path can be obtained. According to a difference between the two height values, an inclination of the glue path can be obtained. These numbers can be directly obtained by a preset calculation formula, and the inclination of any glue path can be obtained after all required data and parameters are collected and processed by a set controller (not illustrated). The controller can determine a distance between the glue application head 10 and the surface of the workpiece along the glue path, and as a result, the distance from the glue application head 10 to the surface of the workpiece can be controlled by controlling a vertical position of the fixed frame 20, so that a glue layer of equal thickness can be obtained to ensure a consistent thickness of the glue layer along all glue paths on the workpiece. Consequently, the present application ensures a good fit between the glue application head 10 and the workpiece, which can effectively prevent no application of the glue or an overflow of the glue.

A bonding equipment includes the gluing mechanism 100 described above.

The present disclosure provides a glue application head for bonding, wherein a glue application structure with a strip-shaped slit is used to spread glue while moving along on a workpiece to form a glue path with a certain line width and shape. In the end, not only can a glue layer with a uniform thickness be obtained, but also a problem of no glue coming out can be prevented. Accordingly, the present disclosure has improved performance in applying the glue on the workpiece, and bonding ability of the glue can also be improved.

The present disclosure also provides a gluing mechanism with the glue application head and a bonding equipment including the gluing mechanism. By monitoring a thickness of the workpiece to control a vertical distance from the glue application head to the workpiece, the present disclosure can ensure a consistent thickness of a glue layer on all glue paths on the workpiece, and allow a good fit between the glue application head and the workpiece, which can effectively prevent problems like no application of the glue or an overflow of the glue on the glue path.

The embodiments of the present disclosure are described in detail above. The described embodiments are only preferable embodiments, and are not intended to limit the protection scope of the present disclosure. All equivalent changes and improvements made based on the protection scope of the present disclosure should be deemed to fall within the protection scope covered by the patent of the present disclosure.

What is claimed is:

1. A glue application head for bonding, comprising a main body, wherein the main body comprises a cavity for accommodating glue and a slit for applying the glue, and the glue application head is configured to apply the glue accommodated in the cavity on a workpiece through the slit to form a glue path with a predetermined line width.

2. The glue application head for bonding according to claim 1, wherein the slit is straight-line shaped and is defined in a lower end surface of the main body.

3. The glue application head for bonding according to claim 1, wherein a length of the slit is greater than 2 mm and less than a width of the workpiece.

4. The glue application head for bonding according to claim 3, wherein the slit is defined along a length direction of the main body, and is defined along a center line of a lower end surface of the main body.

5. The glue application head for bonding according to claim 1, wherein the cavity is a groove with a flat and even surface; the cavity is defined in one sidewall inside the main body, or the cavity is defined in two sidewalls inside the main body and on two sides; and the cavity is defined along an axial plane in a length direction of the main body.

6. The glue application head for bonding according to claim 5, wherein a lower end of the cavity is adapted to a length of the slit, an upper end of the cavity directly communicates with a liquid injection port of the glue application head, and the liquid injection port of the glue application head is arranged on a top of the main body.

7. The glue application head for bonding according to claim 1, wherein a lower section of the main body comprises inclined outer surfaces close to a lower end surface of the main body, and the inclined outer surfaces are all inclined toward the slit.

8. A gluing mechanism with a glue application head for bonding, wherein the glue application head for bonding comprises a main body; the main body comprises a cavity for accommodating glue and a slit for applying the glue; the glue application head is configured to apply the glue accommodated in the cavity on a workpiece through the slit to form a glue path with a predetermined line width; the gluing mechanism is provided with a fixed frame for fixing the glue application head and a glue injection tube for injecting the glue into the glue application head, and the fixed frame is configured to drive the glue application head to move along a vertical direction and move along a width direction and a length direction of the workpiece; and the liquid injection tube is arranged on the fixed frame and directly communicates with a glue injection port of the glue application head.

9. The gluing mechanism according to claim 8, further comprising a measuring instrument for measuring a thickness of the workpiece, the measuring instrument is disposed on the fixed frame, and the measuring instrument is arranged in front of the glue application head in a glue dispensing direction.

10. The gluing mechanism according to claim 8, wherein the slit is a straight-line shaped and is defined in a lower end surface of the main body.

11. The gluing mechanism according to claim 8, wherein a length of the slit is greater than 2 mm and less than a width of the workpiece.

12. The gluing mechanism according to claim 11, wherein the slit is defined along a length direction of the main body, and is defined along a center line of a lower end surface of the main body.

13. The gluing mechanism according to claim 8, wherein the cavity is a groove with a flat and even surface; the cavity is defined in only one sidewall inside the main body, or the cavity is defined in two sidewalls inside the main body and on two sides; and the cavity is defined along an axial plane in a length direction of the main body.

14. The gluing mechanism according to claim 13, wherein a lower end of the cavity is adapted to a length of the slit, an upper end of the cavity directly communicates with a liquid injection port of the glue application head, and the liquid injection port of the glue application head is arranged on a top of the main body.

15. The gluing mechanism according to claim 13, wherein a lower section of the main body comprises inclined outer surfaces close to a lower end surface of the main body, and the inclined surfaces are all inclined toward the slit.

16. A bonding equipment, comprising the gluing mechanism of claim 8.

17. The bonding equipment according to claim 16, further comprising a measuring instrument for measuring a thickness of the workpiece, the measuring instrument is disposed on the fixed frame, and the measuring instrument is arranged in front of the glue application head in a glue dispensing direction.
